(19) United States
(12) Patent Application Publication
(10) Pub. No.: US 2005/0242783 A1
(43) Pub. Date: Nov. 3, 2005

(54) Inverter controlled generator set

(75) Inventors: Masanori Nakagawa, Numazu-shi (JP); Masahiko Endou, Numazu-shi (JP); Kaoru Shinba, Numazu-shi (JP); Katsumi Yamamoto, Numazu-shi (JP); Yoshihiro Sugisawa, Numazu-shi (JP)

Correspondence Address: PEARNE & GORDON LLP, 1801 EAST 9TH STREET, SUITE 1200, CLEVELAND, OH, 44114-3108, US

(73) Assignee: Kokusan Denki Co., Ltd., Numazu-shi (JP)

(21) Appl. No.: 11/114,611

(22) Filed: Apr. 26, 2005

(30) Foreign Application Priority Data
Apr. 28, 2004 (JP) 2004-132472

(51) Int. Cl. H02P 9/06; H02P 3/00; H02P 11/00

(52) U.S. Cl. 322/28

(57) ABSTRACT

An inverter controlled generator set including: an AC generator driven by a prime mover; a converter which converts an output of the AC generator into a DC output; an inverter which converts an output of the converter into an AC output having a predetermined frequency and a rated voltage value; and protection means for blocking the output of the inverter when an output current of the inverter exceeds a predetermined limit value, wherein the AC generator has a drooping characteristic that an output voltage of the AC generator is lowered following an increase of an output current of the AC generator, and wherein the drooping characteristic is a characteristic that the output voltage of the AC generator becomes less than the rated voltage value, when a value of the output current of the AC generator exceeds a set value which is set between the rated value and the limit value of the output current of the inverter.

### TECHNICAL FIELD OF THE INVENTION

The present invention relates to an inverter controlled generator set including an AC generator, a converter which converts an output of the AC generator into a DC output, and an inverter which converts the DC output into an AC output having a desired frequency.

### BACKGROUND OF THE INVENTION

An inverter controlled generator set of a portable type comprises an AC generator driven by an engine, a converter converting an output of the AC generator into a DC output, and inverter converting an output of the converter into an AC output having a desired frequency. A magneto generator, which is constructed so as to generate a three-phase AC output, is often used as the AC generator driven by the engine. The converter comprises a rectifier circuit being consisted by a diode-bridge-type full wave rectifier circuit or a control rectifier circuit consisted by a hybrid-type bridge circuit of diodes and thyristors, and converts an AC output of a generator into a DC output.

The inverter comprises: an inverter circuit which comprises an H-bridge, each arm of a bridge being constituted by a switch element such as a transistor or a FET. In the inverter circuit, a DC output terminal is led out from a common connection point of the switch elements consisting upper arms of the bridge and a common connection point of the switch element consisting lower arms of the bridge, and an AC output terminal is led out from a connection point between the switch elements consisting the upper arms and the switch elements consisting the lower arms. The inverter also comprises a controller for controlling on/off of the switch elements of the inverter circuit so as to obtain an AC output having a fundamental wave component of a predetermined frequency from the AC output terminal of the inverter circuit; and a filter circuit for removing a high harmonic component from the output of the inverter circuit and outputting an AC voltage having a desired frequency, and an output of the filter circuit is supplied to a load. This type of inverter generator set is disclosed in, for example, Japanese Patent Application Laid-Open No. 11-308896.

In a generator having a constant magnetic field, such as a magneto generator, an output voltage V1 to output current I1 characteristic (an output characteristic) when a rotational speed is constant becomes a drooping characteristic as shown in FIG. 2. In an inverter generator set in which an output voltage of such a generator is supplied to an inverter through a connector so as to obtain an AC output of a desired frequency, an output voltage V2 to output current I2 characteristic required by a user is a characteristic in which a constant output voltage can be obtained in a period from a non-load state to an over-load state where the output current reaches a limit value Im as shown in a broken line A of FIG. 3. A curve B in FIG. 3 is a voltage output characteristic of the generator when satisfying the characteristic of the broken line A.

As disclosed in Japanese Patent Application Laid-Open No. 6-165390, a usage of multiple inverter generator sets which are connected in parallel is proposed so as to drive an electric load which can not be driven by one inverter generator set. As being pointed out in Japanese Patent Application Laid-Open No. 6-165390, when operating the multiple inverter generator sets in parallel, if output voltages of the multiple inverter generator sets vary, and a current flows from one generator set having a high output voltage to another generator set having a low output voltage, an overcurrent flows into the generator set into which the current flows, and thus components of the inverter generator set may be destroyed. In Japanese Patent Application Laid-Open No. 6-165390, the overcurrent is prevented from flowing into each inverter generator set by lowering the output voltage when the overcurrent is detected in each inverter generator set. Such a control can prevent a specific inverter generator set from being stopped by the overcurrent before a load value drivable by multiple inverter generator sets reaches a maximum value; thus, a total output of the multiple inverter generator sets operated in parallel can be efficiently used.

If the control disclosed in Japanese Patent Application Laid-Open No. 6-165390 is performed, it is possible to use the total output of the multiple inverter generator sets efficiently when operating the generator sets in parallel. However, in order to perform a control for lowering an output voltage of each inverter generator set when the overcurrent flows into each inverter generator set, it is necessary to provide additional control means, which may cause an increase in cost.

### SUMMARY OF THE INVENTION

Therefore, an object of the invention is to provide an inverter controlled generator set that can be operated in parallel with other inverter generator set or sets to make use of a total output of the generator sets efficiently without using additional control means.

The invention is applied to an inverter controlled generator set including: an AC generator driven by a prime mover such as an engine; a converter which converts an output of the AC generator into a DC output; an inverter which converts an output of the converter into an AC output having a predetermined frequency and a rated voltage value; and protection means for blocking the output of the inverter when an output current of the inverter exceeds a predetermined limit value.

In the present invention, the AC generator has a drooping characteristic that an output voltage of the AC generator is lowered following an increase of an output current of the AC generator. The drooping characteristic is a characteristic that the output voltage of the AC generator becomes less than the rated voltage value, when a value of the output current of the AC generator exceeds a set value which is set between the rated value and the limit value of the output current of the inverter.

In the case that the AC generator of each inverter generator set is allowed to have such characteristic as described above, if output voltages of multiple inverter generator sets vary when operating the multiple inverter generator sets in parallel, and if an output current of the inverter generator set having a high output voltage exceeds a rated value, the output current is decreased spontaneously, and the output currents of the multiple inverter generator sets are balanced until the output current reaches the limit value. Therefore, without providing additional and special control means for controlling the output of the generator set to be lowered when it is detected that the generator is in a overload state, the multiple inverter generator sets can be operated in parallel until each output current of the generator sets reaches the limit value and the total output of the multiple inverter generator sets can be efficiently used.

The present invention is useful especially when a magneto generator, having a rotor in which a magnetic field is constituted by a permanent magneto, is used as said AC generator. In the magneto generator, since an output characteristic always shows a drooping characteristic when a rotational speed of the magneto generator is constant, it is possible to easily obtain a drooping characteristic in which an output voltage of the generator decreases following an increase of an output current of the generator, and the output voltage of the generator becomes lower than the rated voltage when a value of the output current of the generator exceeds a set value which is set between a rated value and a predetermined limit value of an output current of the inverter by adjusting a number of turns of an armature coil of the generator.

According to a preferable aspect of the invention, there is provided rotational speed control means for controlling a rotational speed of the prime mover so as to maintain a constant rotational speed of the AC generator to allow the AC generator (a magneto generator) to have a drooping characteristic in which an output voltage of the generator becomes lower than a rated voltage when an output current of the generator becomes higher than a set value.

In the inverter generator set, a rotational speed of the generator may be controlled so as to increase following an increase of the output current for keeping the output voltage at the rated voltage. In this case, by devising the way to control the rotational speed, the AC generator is allowed to have the above-described characteristic.

According to another preferable aspect of the invention, there is provided rotational speed control means for: changing a rotational speed of the AC generator following a change of the output current of the inverter so as to maintain an output voltage of the inverter constant relative to the change of the output current, when the output current of the inverter is equal to or less than the set value; and controlling a rotational speed of the prime mover which drives the AC generator so as to maintain a rotational speed of the AC generator constant, when the output current of the inverter exceeds the set value.

In further preferable aspect of the invention, there is provided rotational speed control means for: increasing a rotational speed of the AC generator following an increase of the output current of the inverter so as to maintain an output voltage of the inverter constant relative to the change of the output current, when the output current of the inverter is equal to or less than the set value; lowering the rotational speed of the AC generator than a rotational speed required for maintaining the output voltage of the inverter at the rated voltage in a range that the output current of the inverter exceeds the set value; and controlling a rotational speed of the prime mover which drives the generator so that a difference between the rotational speed of the AC generator and the rotational speed required for maintaining the output voltage of the inverter at the rated voltage becomes gradually larger following an increase of the output current of the inverter.

Furthermore, according to another preferable aspect of the invention, there is provided rotational speed control means for: changing a rotational speed of the AC generator according to a change of the output current of the inverter so as to maintain an output voltage of the inverter constant relative to the output current when the output current of the inverter is equal to or less than the set value; and controlling a rotational speed of the prime mover so as to limiting the rotational speed of the AC generator to be equal to or less than a predetermined upper limit value in a range where the output current of the inverter exceeds the set value.

As described above, according to the present invention, the AC generator has the drooping characteristic in which the output voltage of the generator decreases following the increase of the output current of the generator, and the output voltage of the generator becomes lower than the rated voltage of the AC output of the inverter when the value of the output current of the generator exceeds the set value which is set between the rated value and the limit value of the output current of the inverter. Therefore, if the output voltages of the multiple inverter generator sets vary, and if the output current of the inverter generator set having the high output voltage exceeds the set value, the output current is decreased spontaneously, and the output currents of the multiple inverter generator sets are balanced until the output current reaches the limit value. Therefore, without providing additional and special control means for controlling the output of the generator set to be lowered when it is detected that the generator is in a overload state, the multiple inverter generator sets can be operated in parallel until each output current of the generator sets reaches the limit value, and thus, the total output of the multiple inverter generator sets can be efficiently used.

### BRIEF DESCRIPTION OF THE DRAWINGS

The above and other objects and features of the invention will be apparent from the detailed description of the preferred embodiments of the invention, which are described and illustrated with reference to the accompanying drawings, in which;

FIG. 1 is a circuit diagram showing a construction of an embodiment of the invention;

FIG. 2 is a graph showing an output voltage to output current characteristic of an AC generator used as a power source of a conventional inverter generator set;

FIG. 3 is a graph showing an output characteristic of the conventional inverter generator set;

FIG. 4 is a graph showing an output characteristic of an AC generator used in an inverter generator set according to the invention;

FIG. 5 is a circuit diagram of a state where multiple inverter generator sets according to the invention are operated in parallel;

FIG. 6 is a graph showing a performance in the case where an output voltage of one generator set is higher than that of the other generator set, when two inverter generator sets according to the invention are operated in parallel;

FIG. 7 is a graph showing a relation between a current flowing into a load and the magnitude of the load when the two inverter generator sets having a characteristic shown in FIG. 6 are operated in parallel;

FIG. 8 is a graph showing the output characteristic of the AC generator used in the inverter generator set according to the invention, taking a rotational speed as a parameter;

FIG. 9 is a graph showing a rotational speed to output current characteristic for explaining a performance when the rotational speed of the generator is controlled relative to the output current, using the generator having a characteristic shown in FIG. 8, in the inverter generator set according to the invention;

FIG. 10 is a graph showing an example of the rotational speed to output current characteristic when the rotational speed of the generator is controlled relative to the output current, using the generator having the characteristic shown in FIG. 8, in the inverter generator set according to the invention.

### DETAILED DESCRIPTION OF THE PREFERRED EMBODIMENTS

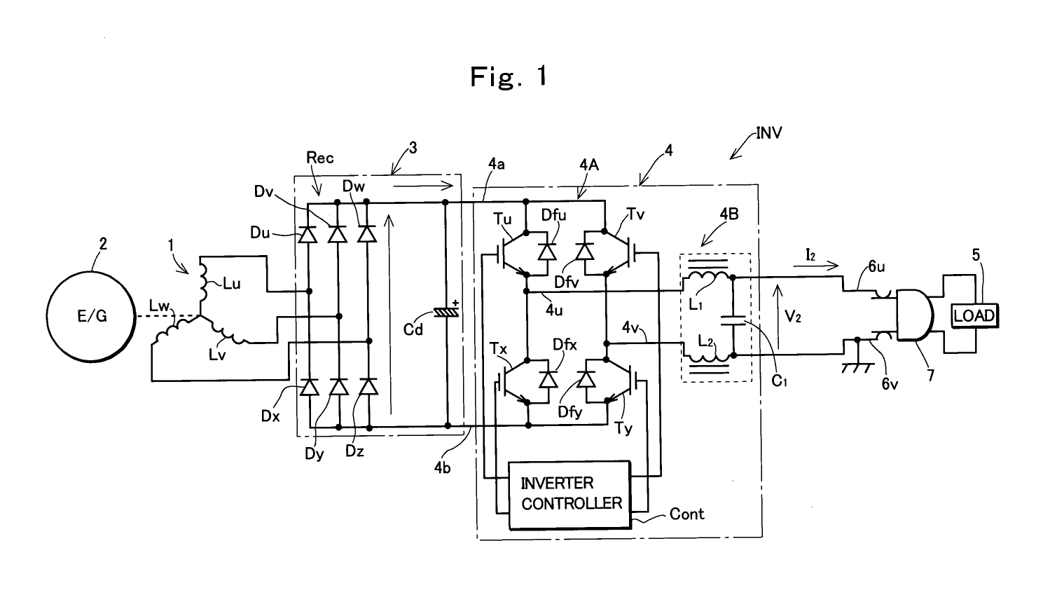

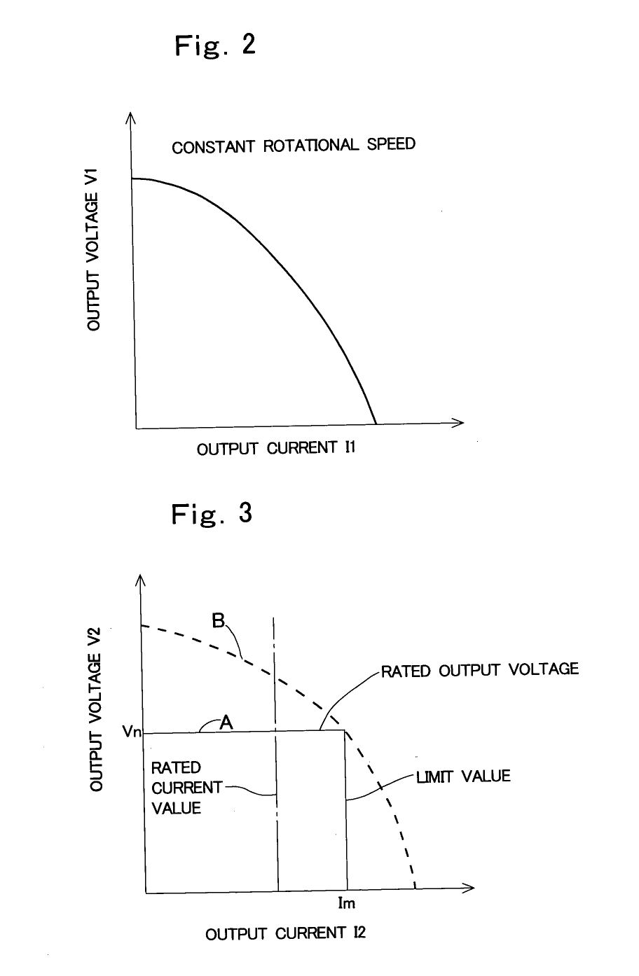

Preferred embodiments of the present invention will be described in further detail with reference to the accompanying drawings. FIG. 1 shows a construction of an inverter controlled generator set INV according to an embodiment of the invention. The inverter generator set INV in FIG. 1 comprises an AC generator 1, a prime mover 2 for driving the generator 1, a converter 3 for converting an AC output of the generator 1 into a DC output, and an inverter 4 for converting an output of the converter 3 into an AC output having a predetermined frequency and a rated voltage. A reference numeral 5 denotes a load being connected through a receptacle 7 to terminals 6u, 6v of a plug which is connected to an output terminal of the inverter generator set INV.

The AC generator 1 is a magneto generator comprising a stator and a rotor having a permanent magnet or a magneto to form a magnetic field. On the side of the stator of the magneto generator, there are provided armature coils Lu to Lw of three phases U, V and W which are star-connected. In this embodiment, an engine is used as a prime mover for driving the AC generator 1.

In the illustrated example, the converter 3 is constructed by a diode bridge full-wave rectifier circuit Rec, which comprises diodes Du to Dw consisting upper side branches of a bridge and diodes Dx to Dz consisting lower side branches of the bridge, and a smoothing capacitor Cd to which an output voltage of the rectifier circuit is applied, and a DC voltage which is obtained across the capacitor Cd is input to the inverter 4.

The inverter 4 comprises an inverter circuit 4A being constructed by an H-bridge circuit of switch elements, a controller Cont for controlling on/off the switch elements of the inverter circuit so as to output from an AC output terminal of the inverter circuit 4A the AC output having a fundamental wave component of a predetermined frequency and a predetermined rated voltage, and a filter circuit 4B for outputting an AC output of the predetermined frequency by removing high harmonic wave components from the output of the inverter circuit.

The inverter circuit 4A is constructed by the H-bridge circuit of the switch elements having switch elements Tu, Tv consisting upper arms of a bridge and switch elements Tx, Ty consisting lower arms of the bridge. DC input terminals 4a and 4b are led out from a common connection point of the switch elements consisting the upper arms of the bridge and a common connection point of the switch elements consisting the lower arms of the bridge, respectively, and the output voltage of the converter is applied between these DC input terminals. Also, AC output terminals 4u and 4v are led out from a connection point between the switch elements consisting the upper arms and the switch elements consisting the lower arms, and an AC voltage obtainable between these AC output terminals is input to the filter circuit 4B.

In the illustrated embodiment, an insulated gate type transistor (IGBT) is used as a switch element consisting each arm of the bridge of the inverter circuit 4A, and feedback diodes Dfu, Dfv, Dfx and Dfy are connected inversely in parallel between collectors and emitters of the IGBTs consisting the switch elements Tu, Tv, Tx and Ty, respectively.

The filter circuit 4B is a low-pass filter comprising coils L1 and L2 and a capacitor C1. The filter removes a high harmonic component from an output of the inverter circuit 4 and outputs an AC voltage of the fundamental wave component. An AC voltage obtained between output terminals of the filter is applied between the terminals 6u and 6v of a plug, and a voltage between the terminals 6u and 6v is applied to a load 5 through a receptacle 7.

The controller Cont includes a microcomputer and comprises inverter control means for controlling on/off the switch elements of the inverter circuit at a predetermined duty ratio so as to output an AC voltage having a commercial frequency and a rated voltage from the inverter circuit 4A, and protection means for setting the switch elements of the inverter circuit 4A an off state, when the output current of the inverter generator set INV exceeds the predetermined limit value, to block the output of the inverter.

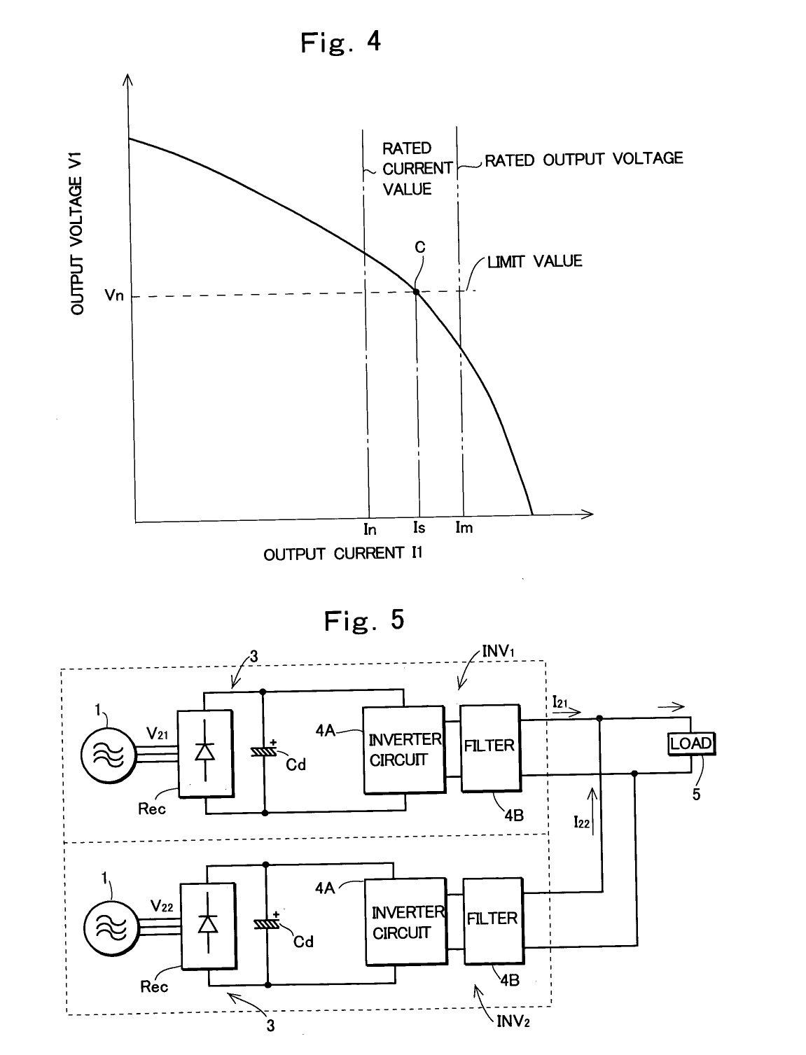

In the invention, as shown in FIG. 4, the AC generator 1 is allowed to have an output characteristic showing a drooping characteristic. In the drooping characteristic, an output voltage V1 of the AC generator decreases following an increase of an output current I1 of the AC generator, and when a value of the output current I1 reaches a set value Is which is set at a value between a rated value In and a limit value Im of the output current of the inverter, an operating point of the AC generator reaches C, and the output voltage V1 of the AC generator becomes lower than the rated voltage Vn of the AC output of the inverter when the value of the output current I1 exceeds the set value Is.

The output current I1 of the AC generator shown in FIG. 4 is a current (an input current of the inverter) output from the converter 3 and is equivalent to the output current I2 of the inverter generator set INV.

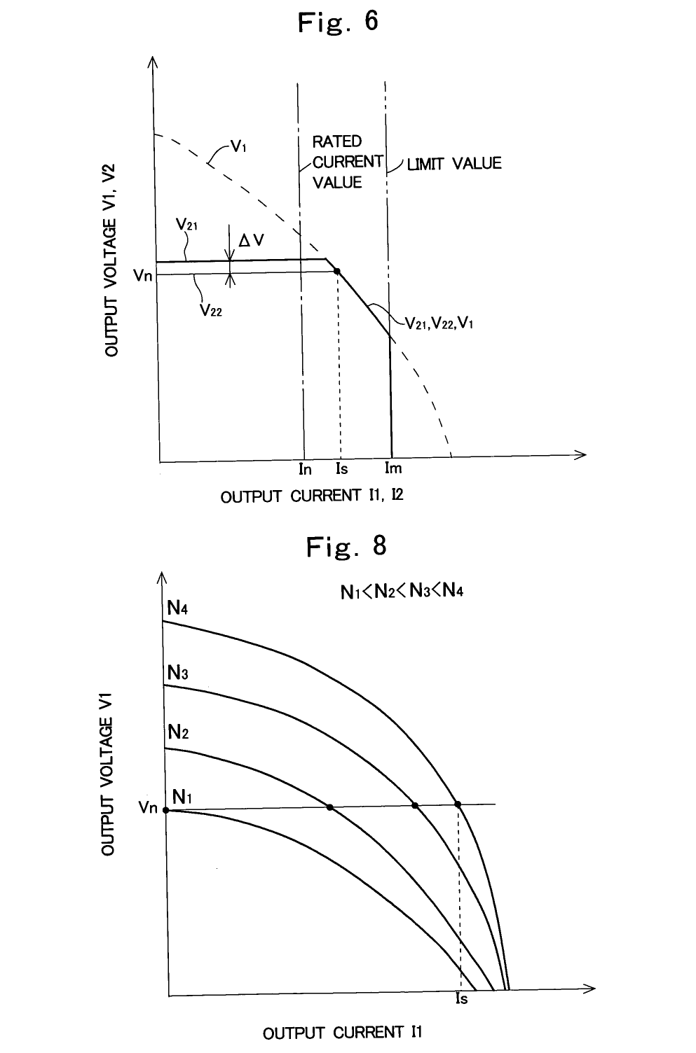

Hereinafter, a case where two inverter generator sets INV1 and INV2 having a construction shown in FIG. 1are operated in parallel to supply an electric power to the load 5 is considered as shown in FIG. 5. In a state where the two inverter generator sets are operated in parallel, it is considered a case where an output voltage V21 of the generator 1 of one inverter generator set INV1 is higher by Δ V than an output voltage V22 of the generator 1 of the other inverter generator set INV2. It is assumed that the output voltage V22 of the generator of the other inverter generator set INV2 is equal to the rated voltage Vn. The currents I1 and I2 plotted along a horizontal axis in FIG. 6 are the output current of the generator in each inverter generator set and the output current (a load current) of each inverter generator set, respectively.

A performance in the case where the output voltage V21 of the generator 1 of one inverter generator set INV1 is higher by Δ V than the output voltage V22 of the generator 1 of the other inverter generator set INV2, as described above, is shown in FIG. 7. In FIG. 7, a reference character I11 denotes the output current of the generator in one inverter generator set INV1, and I12 denotes the output current of the generator in the other inverter generator set INV2. A reference character IL denotes a load current (=I11+I12) which is supplied from two inverter generator sets INV1 and INV2 to the load 5.

When the load current supplied to the load 5 which is common to two inverter generator sets INV1 and INV2 is within a range from zero to the set value Is, the output current I11 of the generator in one inverter generator set INV1 is supplied, as the load current IL, to the load as shown in FIG. 7. At this state, the output current I12 of the generator in the other inverter generator set INV2 is zero. As increasing the load current, the output voltage of one inverter generator set INV1 decreases following the drooping characteristic shown in FIG. 6. When the load current IL(=I11) reaches the set value Is, the output current I12 starts flowing from the other inverter generator set INV2. Until the output current I12 of the other inverter generator set INV2 reaches the set value after the load current reaches the set value, the output current I11 of one inverter generator set INV1 maintains a constant value. When the load further increases, and the output current I12 of the other inverter generator set INV2 reaches the set value Is, the output currents from two generators become well-balanced, thus a total current I11+I12 of the output currents of both generators flows as the load current IL. When the load further increases, and the output currents from both generators reach the limit value Im, the protection means starts operating to block the outputs of both inverter generator sets INV1 and INV2.

Thus, in the invention, as the AC generator is allowed to have the drooping characteristic that the output voltage of the AC generator becomes lower than the rated voltage of the output voltage of the inverter when the output current of the AC generator exceeds the set value which is set between the rated value and limit value of the output current (the load current) of the inverter generator set, if output voltages of multiple inverter generator sets vary, and if the output current of the inverter generator set having a high output voltage exceeds the set value, the load current is decreased spontaneously, and the output currents of the multiple inverter generator sets are balanced until the load current reaches the limit value. Therefore, without providing additional and special control means for controlling the output of the generator set to be lowered when it is detected that the generator is in a overload state, the multiple inverter generator sets can be operated in parallel until each output current of the generator sets reaches the limit value, and thus, the total output of the multiple inverter generator sets can be efficiently used.

In order to allow the AC generator of the inverter generator set to have the above described characteristic, there may be provided rotational speed control means for controlling the rotational speed of the prime mover 2 so as to maintain the rotational speed of the AC generator constant, for example, and the number of winding of the armature coils of the AC generator is set so that the AC generator 1 has the output characteristic showing the drooping characteristic that the output voltage V1 becomes lower than the rated voltage Vn when the output current I1 exceeds the set value Is as shown in FIG. 4.

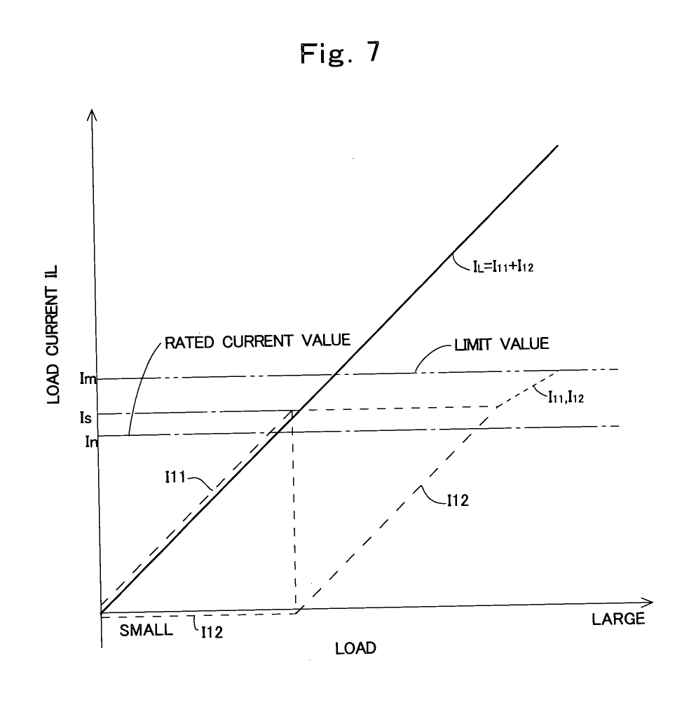

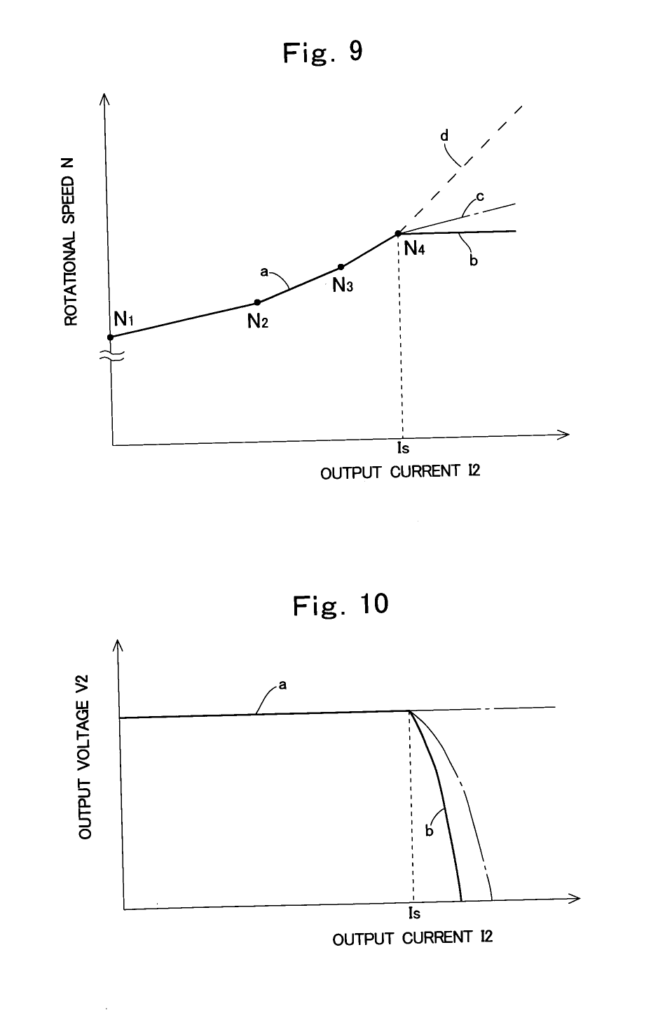

Also, in the case where the AC generator 1 is the magneto generator having the drooping characteristic shown in FIG. 8 with respect to rotational speeds N1 to N4 (N1<N2<N3<N4), by increasing a rotational speed N following a change in the output current I2 of the inverter as shown in a curve a in FIG. 9 for maintaining the output voltage of the converter at the rated voltage Vn to keep the output voltage of the inverter at the rated voltage Vn until the output current I2 of the inverter reaches the set value Is, and by maintaining a rotational speed N of the generator constant in a range where the output current I2 exceeds the set value Is, as shown in a line b in FIG. 9, it is possible to allow the generator to have the output characteristic that the output voltage of the AC generator is lowered following the increase of the output current of the AC generator, and the output voltage of the generator becomes lower than the rated voltage of the AC output of the inverter when the output current of the generator exceeds the set value which is set between the rated value and the limit value of the output current of the inverter.

Thus, with using the AC generator 1 which has a drooping characteristic such as a magneto generator, and with providing the rotational speed control means which controls the rotational speed of the prime mover so that the rotational speed of the AC generator is changed with respect to a change of the output current of the inverter so as to maintain the output voltage of the inverter constant with respect to the output current when the output current of the inverter 4 is equal to or less than the set value, and that the rotational speed N of the AC generator is maintained constant in a region where the output current I2 of the inverter exceeds the set value Is, it is possible to allow the AC generator to have the output characteristic showing the drooping characteristic in which the output voltage becomes lower than the rated voltage when the output current exceeds the set value.

An output voltage V2 to output current I2 characteristic of the inverter generator set, which can be obtained when the rotational speed control means as described above is provided, is shown as a line a and a curve b in FIG. 10.

When a magneto generator having a characteristic shown in FIG. 8 is used, it is possible to allow the AC generator to have the output characteristic showing the drooping characteristic in which the output voltage becomes lower than the rated voltage when the output current exceeds the set value, also by providing the rotational speed control means for controlling the rotational speed of the prime mover 2 of the generator so as to provide a rotational speed to output current characteristic shown in the curves a and c in FIG. 9.

In FIG. 9, a curve d represents a rotational speed to output current characteristic in the case where the rotational speed is controlled so that the output voltage of the inverter generator set is maintained at the rated voltage Vn even in a range where the output current I2 exceeds the set value Is.

Thus, there may be provided the rotational speed control means for: increasing the rotational speed of the AC generator following the increase of the output current of the inverter so as to maintain the output voltage of the inverter constant relative to the change of the output current, when the output current of the inverter is equal to or less than the set value; lowering the rotational speed of the AC generator than the rotational speed required for maintaining the output voltage of the inverter at the rated voltage when the output current of the inverter exceeds the set value; and controlling the rotational speed of the prime mover so that the difference between the rotational speed of the AC generator and the rotational speed required for maintaining the output voltage of the inverter at the rated voltage becomes gradually larger following the increase of the output current of the inverter.

Furthermore, there may be provided rotational speed control means for controlling the rotational speed of the prime mover so that: the rotational speed of an AC generator is changed according to the change of the output current of the inverter so as to maintain the output voltage of the inverter constant relative to the output current when the output current of the inverter is equal to or less than the set value; and the rotational speed of the AC generator is limited to be equal to or less than the predetermined upper limit value when the output current of the inverter exceeds the set value.

In the example shown in FIG. 1, the converter 3 is constructed by the full-wave rectifier circuit and the smoothing capacitor Cd; however, the present invention can be applied to a case where the converter 3 is allowed to have a voltage regulating function to limit a value of a DC voltage being input from the converter 3 into the inverter 4 equal to or less than a rated value (for instance, a rated value equal to the rated voltage of the AC output of the inverter generator set).

Although the preferred embodiments of the invention have been described and illustrated with reference to the accompanying drawings, it will be understood by those skilled in the art that these are by way of example, and that various changes and modifications may be made without departing from the spirit and scope of the invention, which is defined only to the appended claims.

1. An inverter controlled generator set comprising: an AC generator driven by a prime mover; a converter which converts an output of the AC generator into a DC output; an inverter which converts an output of said converter into an AC output having a predetermined frequency and a rated voltage value; and protection means for blocking the output of said inverter when an output current of said inverter exceeds a predetermined limit value,
wherein said AC generator has a drooping characteristic that an output voltage of said AC generator is lowered following an increase of an output current of said AC generator, and
wherein said drooping characteristic is a characteristic that the output voltage of said AC generator becomes less than the rated voltage value, when a value of the output current of said AC generator exceeds a set value which is set between the rated value and the limit value of the output current of said inverter.

2. The inverter controlled generator set according to claim 1, wherein a magneto generator, in which a magnetic field of a rotor is constituted by a permanent magneto, is used as said AC generator.

3. The inverter controlled generator set according to claim 2, wherein rotational speed control means for controlling a rotational speed of said prime mover so as to maintain a constant rotational speed of said AC generator is provided, and
wherein the drooping characteristic of said AC generator is a characteristic that the output voltage of the AC generator becomes lower than the rated voltage when the output current of said AC generator becomes higher than the set value.

4. The inverter controlled generator set according to claim 2, wherein there is provided rotational speed control means for: changing a rotational speed of said AC generator following a change of the output current of said inverter so as to maintain an output voltage of said inverter constant relative to the change of the output current of said inverter, when the output current of said inverter is equal to or less than the set value; and controlling a rotational speed of said prime mover which drives the AC generator so as to maintain the rotational speed of said AC generator constant, when the output current of the inverter exceeds the set value.

5. The inverter controlled generator set according to claim 2, wherein there is provided rotational speed control means for: increasing a rotational speed of said AC generator following an increase of the output current of said inverter so as to maintain an output voltage of said inverter constant relative to the change of the output current of the inverter, when the output current of the inverter is equal to or less than the set value; lowering the rotational speed of said AC generator than a rotational speed required for maintaining the output voltage of the inverter at the rated voltage in a range that the output current of said inverter exceeds the set value; and controlling a rotational speed of said prime mover which drives the generator so that a difference between the rotational speed of the AC generator and the rotational speed required for maintaining the output voltage of the inverter at the rated voltage becomes gradually larger following the increase of the output current of said inverter.

6. The inverter controlled generator set according to claim 2, wherein there is provided rotational speed control means for: changing a rotational speed of said AC generator according to a change of the output current of said inverter so as to maintain an output voltage of said inverter constant relative to the output current of the inverter when the output current of the inverter is equal to or less than the set value; and controlling a rotational speed of said prime mover so as to limiting the rotational speed of said AC generator to be equal to or less than a predetermined upper limit value in a range where the output current of said inverter exceeds the set value.
